(19) United States
(12) Patent Application Publication
(10) Pub. No.: US 2020/0242541 A1
(43) Pub. Date: Jul. 30, 2020

(54) INFORMATION PROCESSING SYSTEM, INFORMATION PROCESSING APPARATUS, INFORMATION PROCESSING METHOD, AND INFORMATION PROCESSING PROGRAM

(71) Applicant: NEC Corporation, Minato-ku, Tokyo (JP)

(72) Inventors: Dai KINNO, Tokyo (JP); Kota IWAMOTO, Tokyo (JP); Kanako TAGA, Tokyo (JP)

(73) Assignee: NEC Corporation, Minato-ku, Tokyo (JP)

(21) Appl. No.: 16/489,773

(22) PCT Filed: Jan. 18, 2018
(86) PCT No.: PCT/JP2018/001369

§ 371 Date: Aug. 29, 2019

(30) Foreign Application Priority Data
Mar. 3, 2017 (JP) 2017-040120
Mar. 3, 2017 (JP) 2017-040121

(51) Int. Cl. G06Q 10/08; G06F 16/29; H04N 7/18; H04N 5/232; G06T 7/20

(52) U.S. Cl. CPC G06Q 10/087; G06F 16/29; G06T 7/20; H04N 5/23299; H04N 7/18

(57) ABSTRACT

A store is operated more efficiently. There is provided an information processing system including at least one image capturer, a moving unit, and a controller. The at least one image capturer included in the information processing system captures a store shelf. The moving unit included in the information processing system moves the at least one image capturer. The controller included in the information processing system controls image capturing by the at least one image capturer and movement of the at least one image capturer by the moving unit at a predetermined timing.

This application is based upon and claims the benefit of priority from Japanese patent application Nos. 2017-040120 and 2017-040121, filed on Mar. 3, 2017, the disclosure of which is incorporated herein in its entirety by reference.

### TECHNICAL FIELD

The present invention relates to an information processing system, an information processing apparatus, an information processing method, and an information processing program.

### BACKGROUND ART

In the above technical field, patent literature 1 discloses a technique of checking whether a product is arranged appropriately by shooting a store shelf.

### CITATION LIST

### Patent Literature

Patent literature 1: Japanese Patent Laid-Open No. 2017-14014

Patent literature 2: Japanese Patent Laid-Open No. 2016-58105

### SUMMARY OF THE INVENTION

### Technical Problem

In the technique described in patent literature 1, however, since the timing of image capturing and movement of a camera is not taken into consideration, it is impossible to operate a store more efficiently.

The present invention enables to provide a technique of solving the above-described problem.

### Solution to Problem

One example aspect of the present invention provides an information processing system comprising:

at least one image capturer that captures a store shelf;

a moving unit that moves the image capturer; and

a controller that controls image capturing by the image capturer and movement of the image capturer by the moving unit at a predetermined timing.

Another example aspect of the present invention provides an information processing apparatus comprising:

a timing generator that generates, based on taking-in/out of a product in a store, a timing of image capturing of at least one image capturer that captures a store shelf and movement of the image capturer by a moving unit; and

a controller that controls image capturing by the image capturer and movement of the image capturer by the moving unit at the timing.

Still other example aspect of the present invention provides an information processing method comprising:

generating, based on taking-in/out of a product in a store, a timing of image capturing of at least one image capturer that captures a store shelf and movement of the image capturer by a moving unit; and

controlling image capturing by the image capturer and movement of the image capturer by the moving unit at the timing.

Still other example aspect of the present invention provides an information processing program for causing a computer to execute a method, comprising:

generating, based on taking-in/out of a product in a store, a timing of image capturing of at least one image capturer that captures a store shelf and movement of the image capturer by a moving unit; and

controlling image capturing by the image capturer and movement of the image capturer by the moving unit at the timing.

### Advantageous Effects of Invention

According to the present invention, it is possible to operate a store more efficiently.

### BRIEF DESCRIPTION OF DRAWINGS

FIG. 1 is a block diagram showing the arrangement of an information processing system according to the first example embodiment of the present invention;

FIG. 2 is a view for explaining an overview of an information processing system according to the second example embodiment of the present invention;

FIG. 3 is a block diagram showing the arrangement of the information processing system according to the second example embodiment of the present invention;

FIG. 4 is a table showing an example of a control table provided in an information processing apparatus included in the information processing system according to the second example embodiment of the present invention;

FIG. 5 is a block diagram for explaining the hardware arrangement of the information processing apparatus included in the information processing system according to the second example embodiment of the present invention;

FIG. 6 is a flowchart for explaining the processing procedure of the information processing apparatus included in the information processing system according to the second example embodiment of the present invention;

FIG. 7 is a block diagram showing the arrangement of an information processing system according to the third example embodiment of the present invention;

FIG. 8 is a table showing an example of a stock table provided in an information processing apparatus included in the information processing system according to the third example embodiment of the present invention;

FIG. 9 is a block diagram for explaining the hardware arrangement of the information processing apparatus included in the information processing system according to the third example embodiment of the present invention;

FIG. 10 is a flowchart for explaining the processing procedure of the information processing apparatus included in the information processing system according to the third example embodiment of the present invention;

FIG. 11 is a block diagram showing the arrangement of an information processing system according to the fourth example embodiment of the present invention;

FIG. 12A is a view for explaining an overview of an information processing system according to the fifth example embodiment of the present invention;

FIG. 12B is a view for explaining an overview of a selling area in the information processing system according to the fifth example embodiment of the present invention;

FIG. 12C is a view for explaining an overview of a back room in the information processing system according to the fifth example embodiment of the present invention;

FIG. 13 is a block diagram showing the arrangement of the information processing system according to the fifth example embodiment of the present invention;

FIG. 14 is a table showing an example of a product table provided in an information processing apparatus included in the information processing system according to the fifth example embodiment of the present invention;

FIG. 15 is a block diagram for explaining the hardware arrangement of the information processing apparatus included in the information processing system according to the fifth example embodiment of the present invention;

FIG. 16 is a flowchart for explaining the processing procedure of the information processing apparatus included in the information processing system according to the fifth example embodiment of the present invention;

FIG. 17 is a block diagram showing the arrangement of an information processing system according to the sixth example embodiment of the present invention;

FIG. 18 is a table showing an example of a control table provided in an information processing apparatus included in the information processing system according to the sixth example embodiment of the present invention;

FIG. 19 is a block diagram for explaining the hardware arrangement of the information processing apparatus included in the information processing system according to the sixth example embodiment of the present invention;

FIG. 20 is a flowchart for explaining the processing procedure of the conveyor of the information processing system according to the sixth example embodiment of the present invention;

FIG. 21A is a side view for explaining examples of an image capturer and a moving unit in an information processing system according to the seventh example embodiment of the present invention;

FIG. 21B is a front view for explaining other examples of the image capturer and the moving unit in the information processing system according to the seventh example embodiment of the present invention; and

FIG. 21C is a side view for explaining still other examples of the image capturer and the moving unit in the information processing system according to the seventh example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

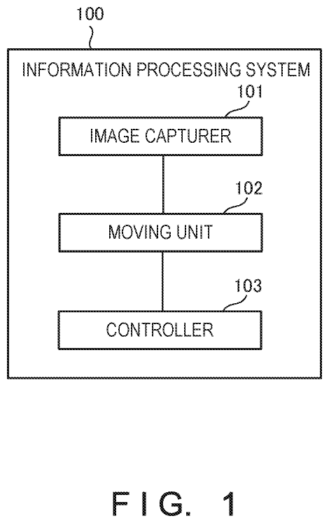

An information processing system 100 according to the first example embodiment of the present invention will be described with reference to FIG. 1. The information processing system 100 is a system that controls image capturing and movement of an image capturer at a predetermined timing.

As shown in FIG. 1, the information processing system 100 includes an image capturer 101, a moving unit 102, and a controller 103. The image capturer 101 captures a store shelf. There is provided at least one image capturer 101. The moving unit 102 moves the image capturer 101. The controller 103 controls image capturing by the image capturer 101 and movement by the moving unit 102 at a predetermined timing.

According to this example embodiment, it is possible to operate a store more efficiently.

### Second Example Embodiment

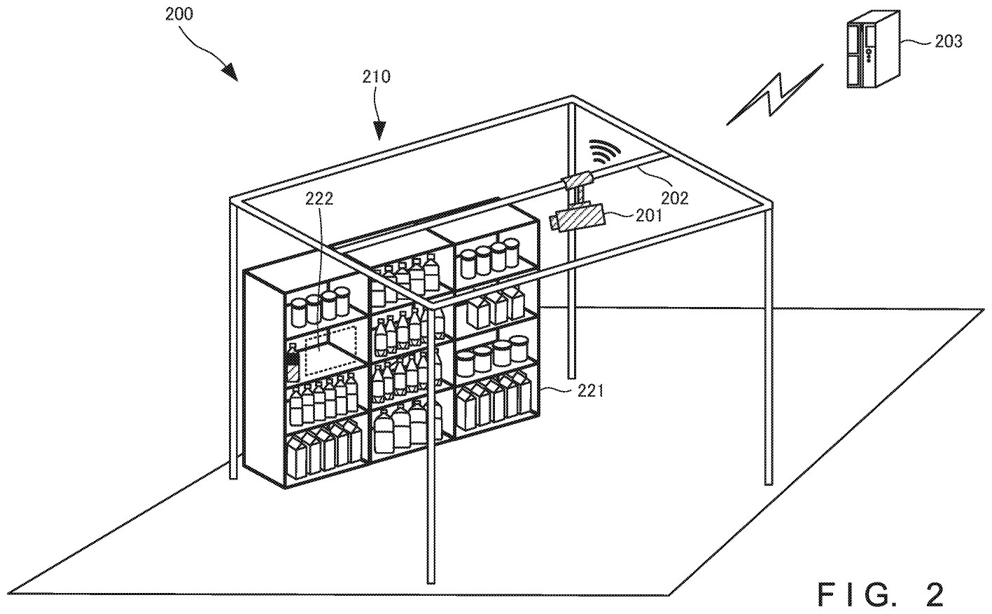

An information processing system 200 according to the second example embodiment of the present invention will be described next with reference to FIGS. 2 to 6. FIG. 2 is a view for explaining an overview of the information processing system according to this example embodiment. The information processing system 200 includes a camera 201, a rail 202, and an information processing apparatus 203.

The camera 201 can move in a selling area 210 in a store along the rail 202. Furthermore, the camera 201 is attached to the rail 202 via an attachment including a pulley. To detect a stockout product 222, the information processing apparatus 203 controls to move the camera 201 and capture an image of a store shelf 221 at a predetermined timing. Note that although the image captured by the camera 201 is a still image, the present invention is not limited to this and the captured image may be a moving image.

The camera 201 captures the store shelf 221 in the selling area 210. The camera 201 transmits a captured image of the store shelf 221 to the information processing apparatus 203. Upon receiving the image of the store shelf 221, the information processing apparatus 203 detects the stockout product 222 based on the captured image of the store shelf 221.

Note that an example in which the rail 202 is provided on the ceiling of the selling area 210 has been explained. However, the rail 202 may be provided, for example, between the store shelf 221 and a wall. If the store shelves 221 are arranged back to back, the rail 202 may be provided between the store shelves 221. Furthermore, the camera 201 may be movable not only in the lateral direction (horizontal direction) but also in the longitudinal direction (vertical direction).

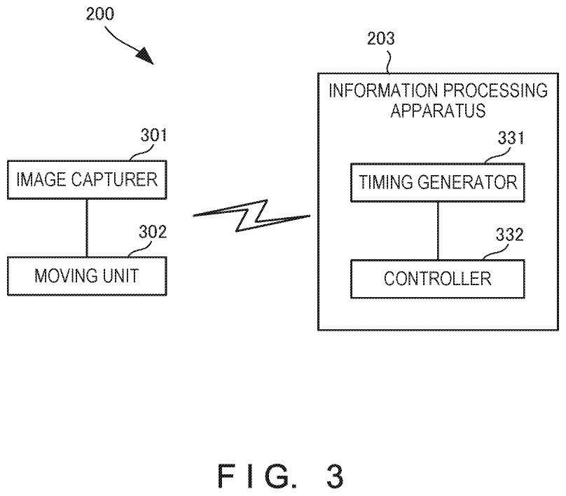

FIG. 3 is a block diagram showing the arrangement of the information processing system 200 according to this example embodiment. The information processing system 200 includes an image capturer 301, a moving unit 302, and the information processing apparatus 203. The image capturer 301 moves in the store and captures an image of the store shelf 221. Although the image captured by the image capturer 301 is a still image, the present invention is not limited to this and the captured image may be a moving image. Furthermore, one or a plurality of image capturers 301 may be provided.

The moving unit 302 moves the image capturer 301. The moving unit 302 includes, for example, the rail 202 provided on the ceiling of the store, and the image capturer 301 moves in the store by moving along the rail 202. The image capturer 301 is attached to the moving unit 302 via an attachment including a pulley or the like.

The information processing apparatus 203 includes a timing generator 331 and a controller 332. Based on taking-in/out of a product in the store, the timing generator 331 generates a timing of image capturing and movement of the image capturer 301 that captures the store shelf 221 by moving in the store. That is, based on taking-in/out of a product, for example, selling of a product or arrival of a product, the timing generator 331 generates a timing to be used as a trigger by the image capturer 301 to start movement and perform image capturing.

The timing is, for example, a timing after detecting a change in state of the store shelf 221. More specifically, the timing is a timing after a store visitor to the store takes the product in his/her hand from the store shelf 221, checks out at a register, and goes out of the store. That is, the product is sold and taken away from the store shelf 221, resulting in a change in display state of the product on the store shelf 221. In this case, for example, if a sensor that detects the display state of the product on the store shelf 221 is provided, and the sensor and a POS (Point Of Sales) system are made to synchronize with each other, it is possible to detect a change in state of the store shelf 221. Therefore, the timing generator 331 generates, as a timing for controlling image capturing and movement of the image capturer 301, a timing after detecting a change in state of the store shelf 221.

Another timing is a timing at which the product arrives at the store. If the product arrives at the store, the product is stored as stock in the back room of the store. Thus, if a stockout product can be detected, it can be replenished.

To the contrary, if there is no stock product in the back room, even if the camera 201 is moved to detect the stockout product, movement of the camera 201 is useless since there is no product to be replenished in the back room. Therefore, the timing generator 331 generates, as a timing for controlling image capturing and movement of the image capturer 301, a timing at which a product arrives at the store.

Still other timing is a timing a predetermined time before the sales deadline of the product displayed on the store shelf 221 in the selling area 210 in the store, for example, a best-before date or an expiration date. For example, since selling an expired product in a store such as a convenience store or supermarket injures the reputation of the store for various reasons, the product needs to be replaced before it is expired. Therefore, the camera 201 is moved to capture an image of the store shelf 221 the predetermined time before the sales deadline of the product displayed on the store shelf 221. In this case, if the product arrives, a clerk performs arrival processing to input, to the POS system or the like, data such as an arrived product name, a product quantity, an arrival date/time, and a sales deadline. Therefore, the information processing apparatus 203 can generates a timing the predetermined time before the sales deadline of the product by using the input data. For example, 5 min or 10 min is decided as the predetermined time based on the time taken to replace the product. However, a method of deciding the predetermined time is not limited to this.

Still other timing is a timing after the product is sold, that is, a timing after the product displayed on the store shelf 221 is sold to a store visitor. In this case as well, if the information processing apparatus 203 and the POS system synchronize with each other, the timing generator 331 generates a timing when the information processing apparatus 203 receives, from the POS system, information indicating that the product is sold.

Furthermore, still other timing is, for example, a timing after detecting store visitors concentrating around the predetermined store shelf 221. If store visitors concentrate in front of the predetermined store shelf 221, the product on the store shelf 221 is sold and the possibility of occurrence of stockout is high. Therefore, the timing generator 331 generates such timing as a timing for controlling image capturing and movement of the image capturer 301. This allows the information processing apparatus 203 to control the image capturer 301 at this timing to capture an image of the store shelf 221. In this case, while detecting concentration of store visitors from a video of a monitoring camera in the store or the like, the store shelf 221 where the store visitors concentrate is specified, and these pieces of information are provided to the information processing apparatus 203. This allows the information processing apparatus 203 to control the image capturer 301.

The controller 332 controls image capturing by the image capturer 301 and movement of the image capturer 301 by the moving unit 302 at the timing generated by the timing generator 331. The controller 332 performs control by transmitting, to the image capturer 301 and the moving unit 302, a signal concerning a position in the selling area 210 in the store, at which the store shelf 221 to be captured exists. Note that the moving unit 302 includes the rail 202 installed in the store, and the rail 202 is installed, for example, on the ceiling of the store.

The controller 332 shortens the interval of control of image capturing by the image capturer 301 and movement by the moving unit 302 in a predetermined time period before the start of an event around the store. It is expected that store visitors concentrate a predetermined time period, for example, an hour to 10 min before the event is held around the store, and the possibility of occurrence of stockout is high. Therefore, to cope with this situation, during this time period, the controller 332 shortens the interval of control of the image capturer 301 to control the image capturer 301 to perform image capturing and movement frequently. If the image capturer 301 is moved frequently to capture the store shelf 221 by shortening the interval of control in this way, detection of a stockout product is easy.

Note that if there are a plurality of store shelves 221 to be captured by the image capturer 301, the controller 332 may decide a patrol route of the image capturer 301, which indicates how to move the image capturer 301. Then, the controller 332 may perform control to move the image capturer 301 along the decided patrol route and capture the store shelves 221.

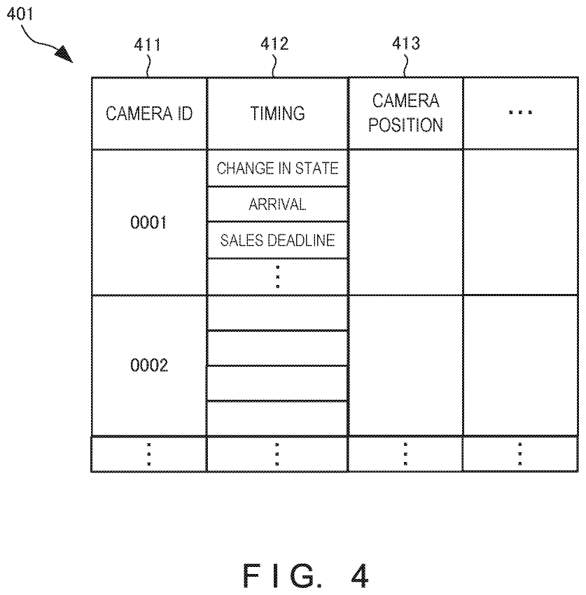

FIG. 4 is a table showing an example of a control table 401 provided in the information processing apparatus 203 included in the information processing system 200 according to this example embodiment. The control table 401 stores a timing 412 and a camera position 413 in association with a camera ID (IDentifier) 411. The camera ID 411 is an identifier for identifying a camera as the image capturer 301. The timing 412 is a timing of controlling movement and image capturing of the image capturer 301. The camera position 413 is, for example, information concerning a position such as the current position of the image capturer 301. For example, the controller 332 of the information processing apparatus 203 controls image capturing and movement of the image capturer 301 with reference to the control table 401.

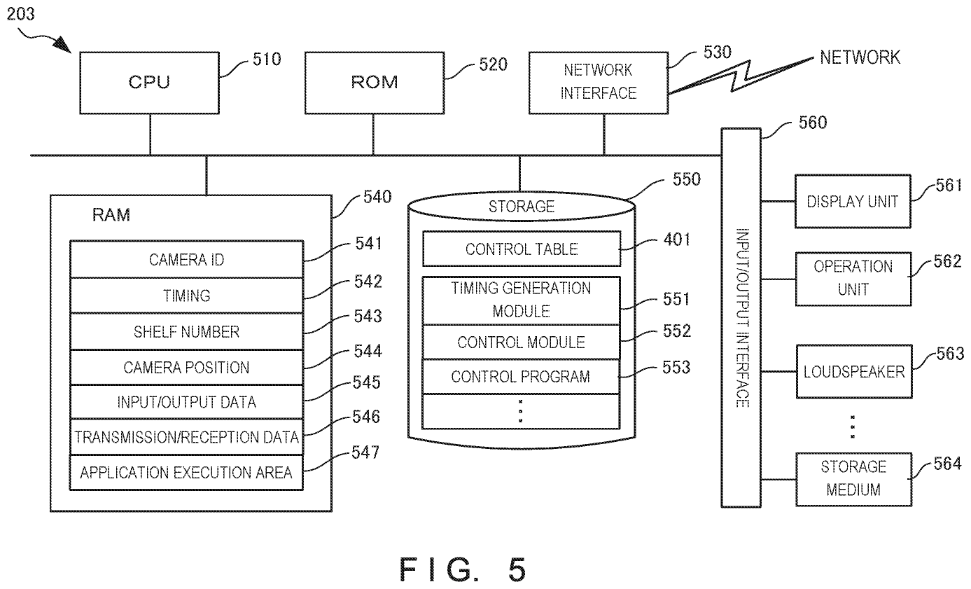

FIG. 5 is a block diagram for explaining the hardware arrangement of the information processing apparatus 203 included in the information processing system according to this example embodiment. A CPU (Central Processing Unit) 510 is an arithmetic control processor, and implements the functional components of the information processing apparatus 203 shown in FIG. 3 by executing a program. The CPU 510 may include a plurality of processors and execute different programs, modules, tasks, or threads in parallel. A ROM (Read Only Memory) 520 stores permanent data such as initial data and a program, and other programs. A network interface 530 communicates with another apparatus or the like via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads transmission/reception data in or from the area of a RAM (Random Access Memory) 540. It is desirable to provide a DMAC (Direct Memory Access Controller) (not shown) for transferring data between the RAM 540 and a storage 550. An input/output interface 560 desirably includes a CPU independent of the CPU 510, and writes or reads input/output data in or from the area of the RAM 540. Therefore, the CPU 510 recognizes that data has been received by the RAM 540 or transferred to the RAM 540, and processes the data. The CPU 510 prepares a processing result in the RAM 540, and delegates succeeding transmission or transfer to the network interface 530, the DMAC, or the input/output interface 560.

The RAM 540 is a random access memory used as a temporary storage work area by the CPU 510. An area to store data necessary for implementation of the example embodiment is allocated to the RAM 540. A camera ID 541 is an identifier for identifying a camera in the store. A timing 542 is data representing a timing of controlling movement and image capturing of the camera 201. A shelf number 543 is data representing the position of the store shelf 221 on which a product is displayed or the storage location of a product in the back room. A camera position 544 is data representing the current position of the camera 201 or the like. These data are data loaded from, for example, the control table 401.

Input/output data 545 is data input/output via the input/output interface 560. Transmission/reception data 546 is data transmitted/received via the network interface 530. The RAM 540 includes an application execution area 547 used to execute various application modules.

The storage 550 stores a database, various parameters, or the following data or programs necessary for implementation of this example embodiment. The storage 550 stores the control table 401. The control table 401 is the table, shown in FIG. 4, for managing the relationship among the camera ID 411, the timing 412, the camera position 413, and the like.

The storage 550 further stores a timing generation module 551 and a control module 552.

The timing generation module 551 is a module that generates, based on taking-in/out of a product in the store, a timing of image capturing and movement of the image capturer 301 that moves in the store to capture the store shelf 221. The control module 552 is a module that controls image capturing by the image capturer 301 and movement by the moving unit 302 at the predetermined timing. These modules 551 and 552 are loaded to the application execution area 547 of the RAM 540 and executed by the CPU 510. A control program 553 is a program for controlling the overall information processing apparatus 203.

The input/output interface 560 interfaces input/output data with an input/output device. The input/output interface 560 is connected to a display unit 561 and an operation unit 562. The input/output interface 560 may also be connected to a storage medium 564. Furthermore, a loudspeaker 563 serving as a voice output unit, a microphone (not shown) serving as a voice input unit, or a GPS position determiner may be connected. Note that programs and data that are associated with the general-purpose functions of the information processing apparatus 203 and other feasible functions are not shown in the RAM 540 or the storage 550 of FIG. 5.

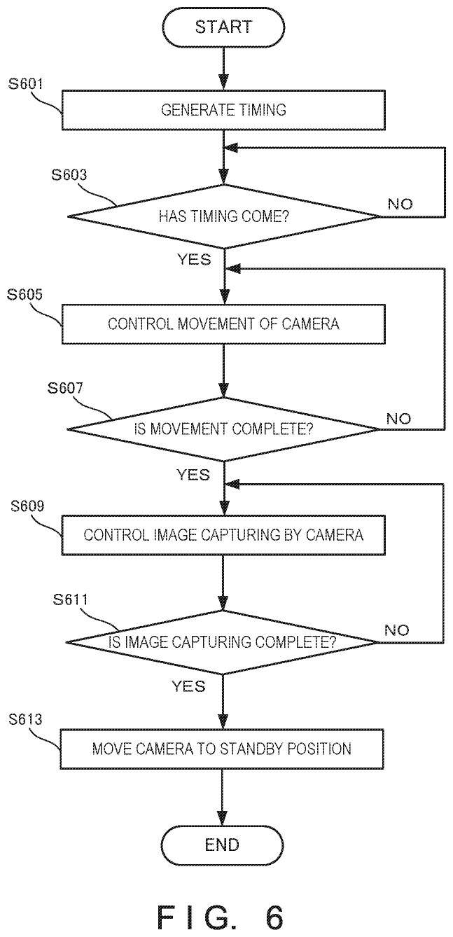

FIG. 6 is a flowchart for explaining the processing procedure of the information processing apparatus 203 of the information processing system 200 according to this example embodiment. This flowchart is executed by the CPU 510 of FIG. 5 using the RAM 540, thereby implementing the functional components of the information processing apparatus 203 shown in FIG. 3.

In step S601, the information processing apparatus 203 generates a timing of controlling movement and image capturing of the camera 201. In step S603, the information processing apparatus 203 determines whether the timing of controlling movement and image capturing of the camera 201 has come. If the timing has not come (NO in step S603), the information processing apparatus 203 stands by until the timing comes; otherwise (YES in step S603), the information processing apparatus 203 advances to step S605.

In step S605, the information processing apparatus 203 controls movement of the camera 201 to move to a predetermined position. In step S607, the information processing apparatus 203 determines whether movement of the camera 201 is complete. If movement of the camera 201 is not complete (NO in step S607), the information processing apparatus 203 continues to control movement of the camera 201; otherwise (YES in step S607), the information processing apparatus 203 advances to step S609.

In step S609, the information processing apparatus 203 controls image capturing by the camera 201 to capture an image of the store shelf 211. In step S611, the information processing apparatus 203 determines whether image capturing by the camera 201 is complete. If image capturing is not complete (NO in step S611), the information processing apparatus 203 continues to control image capturing by the camera 201; otherwise (YES in step S611), the information processing apparatus 203 advances to step S613.

In step S613, for example, the information processing apparatus 203 moves the camera 201 to a standby position to make the camera 201 stand by, thereby ending the processing.

According to this example embodiment, since movement and image capturing of the camera are controlled at the predetermined timing, it is possible to control image capturing and movement of the camera efficiently.

### Third Example Embodiment

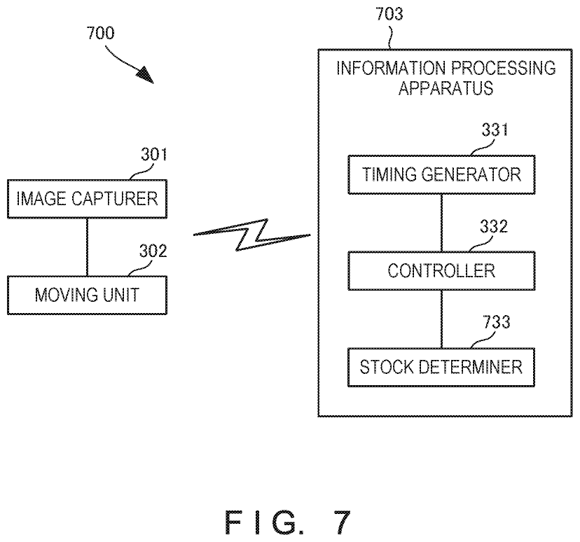

An information processing system according to the third example embodiment of the present invention will be described next with reference to FIGS. 7 to 10. FIG. 7 is a block diagram for explaining the arrangement of an information processing system 700 according to this example embodiment. The information processing system 700 according to this example embodiment is different from that in the second example embodiment in that an information processing apparatus includes a stock determiner. The remaining components and operations are the same as those in the second example embodiment. Hence, the same reference numerals denote the same components and operations, and a detailed description thereof will be omitted.

An information processing apparatus 703 includes a stock determiner 733. The stock determiner 733 determines whether there is stock of a product in the back room of a store. Then, a controller 332 controls image capturing and movement of an image capturer 301 based on a determination result by the stock determiner 733. For example, even if, in a state in which there is no stock of the product in the back room, a stockout product is detected by controlling the image capturer 301 to capture a store shelf 211, control of the image capturer 301 is useless since the product to be replenished is not stored in the back room. Therefore, even if the predetermined timing has come and the controller 332 should control the image capturer 301, if there is no stock of the product, the stock determiner 733 suppresses control of the image capturer 301.

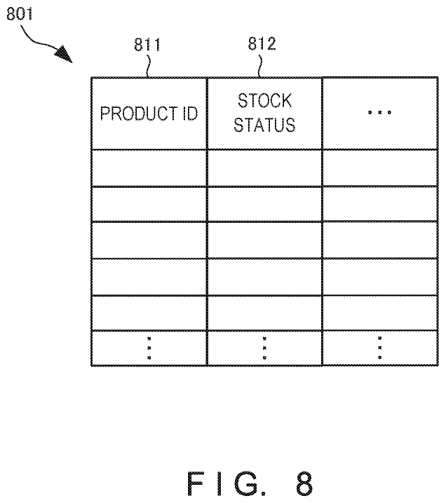

FIG. 8 is a table showing an example of a stock table 801 provided in the information processing apparatus 703 included in the information processing system 700 according to this example embodiment. The stock table 801 stores a stock status 812 in association with a product ID 811. The product ID (IDentifier) 811 is an identifier for identifying a product. The stock status 812 is information concerning the stock status of a product, for example, a remaining product quantity, the presence/absence of stock, and a scheduled arrival date/time. Then, for example, the information processing apparatus 703 controls the image capturer 301 with reference to the stock table 801.

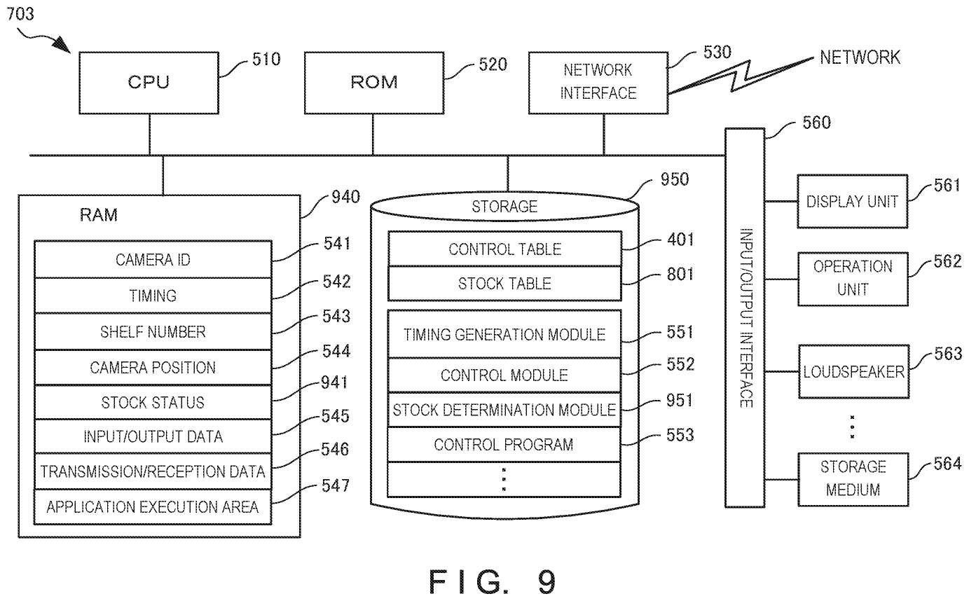

FIG. 9 is a block diagram for explaining the hardware arrangement of the information processing apparatus 703 included in the information processing system according to this example embodiment. A RAM 940 is a random access memory used as a temporary storage work area by a CPU 510. An area to store data necessary for implementation of this example embodiment is allocated to the RAM 940. A stock status 941 is data concerning the stock status of a product. This data is data loaded from, for example, the stock table 801.

A storage 950 stores a database, various parameters, or the following data or programs necessary for implementation of this example embodiment. The storage 950 stores the stock table 801. The stock table 801 is the table, shown in FIG. 8, for managing the relationship between the product ID 811 and the stock status 812.

The storage 950 further stores a stock determination module 951. The stock determination module 951 is a module that determines whether there is stock of a product in the back room. This module 951 is loaded to an application execution area 547 of the RAM 540 and executed by the CPU 510.

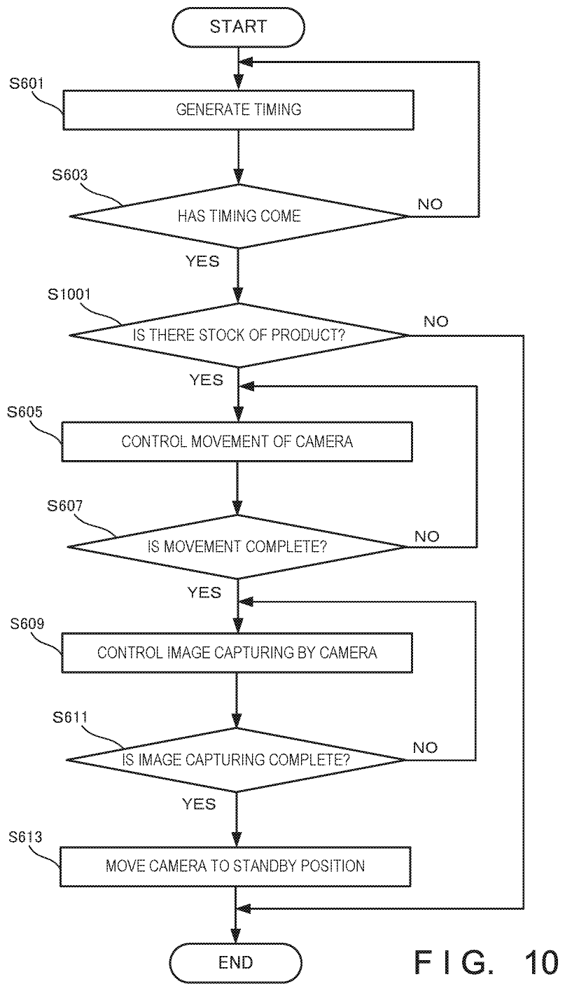

FIG. 10 is a flowchart for explaining the processing procedure of the information processing apparatus 703 of the information processing system 700 according to this example embodiment. This flowchart is executed by the CPU 510 of FIG. 9 using the RAM 540, thereby implementing the functional components of the information processing apparatus 703 shown in FIG. 7.

In step S1001, the information processing apparatus 703 determines the presence/absence of stock of the product. If there is stock of the product (YES in step S1001), the information processing apparatus 703 advances to step S605; otherwise (NO in step S1001), the information processing apparatus 703 ends the processing not to control movement and image capturing of the image capturer 301.

According to this example embodiment, since the presence/absence of stock is determined, useless control can be reduced, thereby making it possible to detect a stockout product more efficiently.

### Fourth Example Embodiment

In this technical field, patent literature 2 discloses a technique of determining the display shortage state of a product in each state monitoring area, and superimposing, on a video of a display area, a display state display image in accordance with the degree of the shortage of the product for each state monitoring area. In the technique described in patent literature 2, however, it is impossible to perform product management more efficiently. This example embodiment enables to provide a technique of solving the above-described problem.

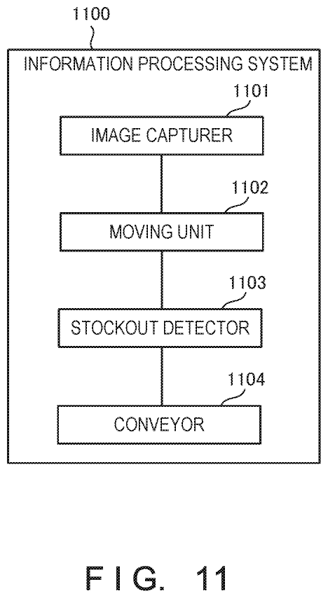

An information processing system 1100 according to the fourth example embodiment of the present invention will be described with reference to FIG. 11. The information processing system 1100 is a system that detects stockout of a product and conveys a stockout product into a store.

As shown in FIG. 11, the information processing system 1100 includes an image capturer 1101, a moving unit 1102, a stockout detector 1103, and a conveyor 1104.

The image capturer 1101 captures a store shelf. There is provided at least one image capturer 1101. The moving unit 1102 moves the image capturer 1101. The stockout detector 1103 detects stockout of a product based on an image of the store shelf captured by the image capturer 1101. The conveyor 1104 conveys, from a back room into the store, a stockout product detected by the stockout detector 1103.

According to this example embodiment, it is possible to perform product management more efficiently.

### Fifth Example Embodiment

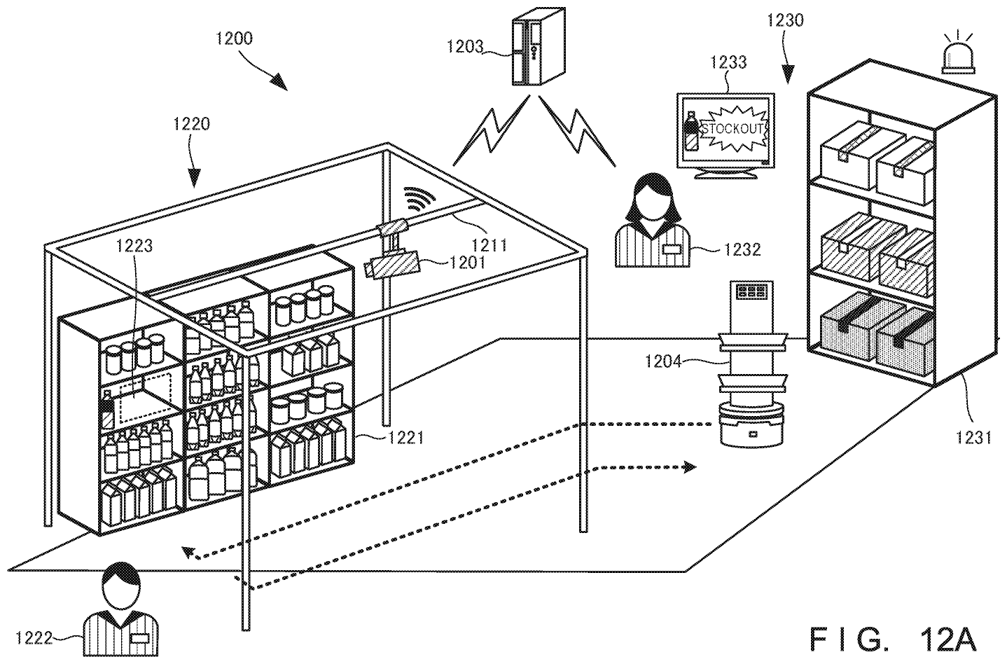

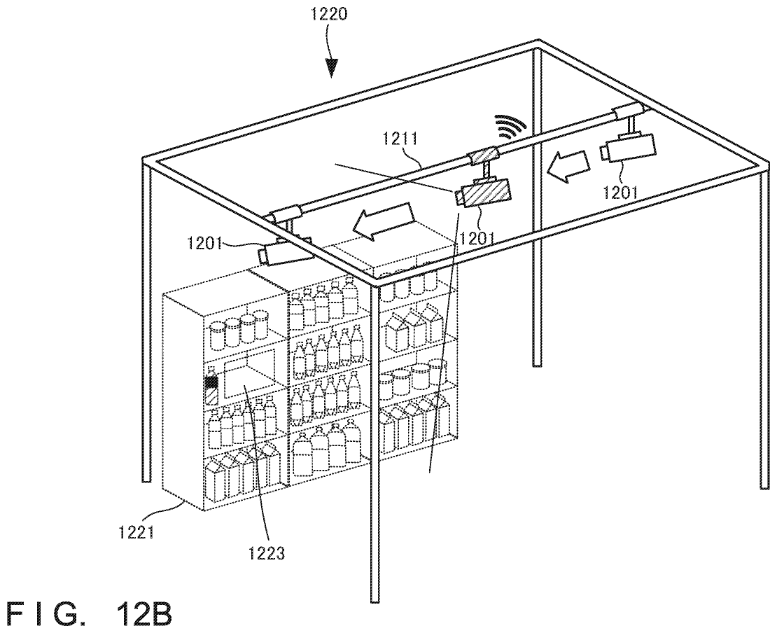

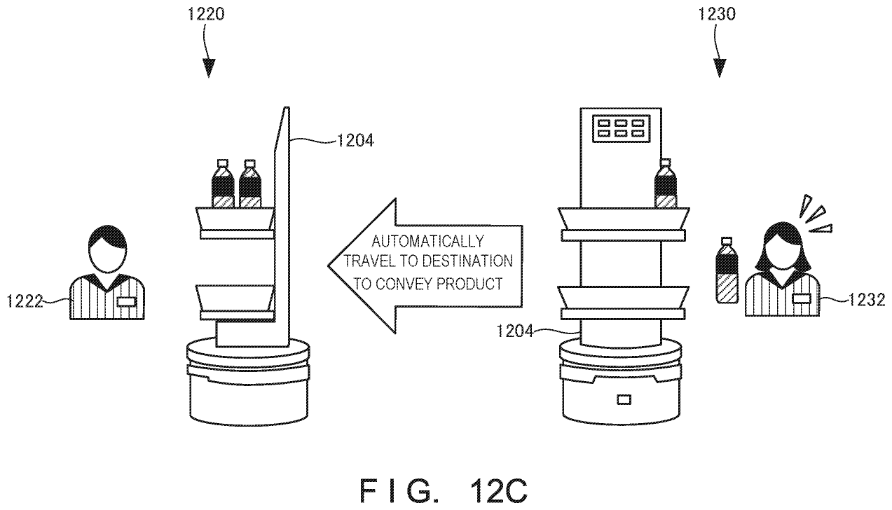

An information processing system according to the fifth example embodiment of the present invention will be described next with reference to FIGS. 12A to 16. FIG. 12A is a view for explaining an overview of an information processing system 1200 according to this example embodiment. FIG. 12B is a view for explaining an overview of a selling area in the information processing system 1200 according to this example embodiment. FIG. 12C is a view for explaining an overview of a back room in the information processing system 1200 according to this example embodiment.

The information processing system 1200 is, for example, a system that detects a stockout product on a store shelf in a convenience store, a supermarket, or the like, and conveys, to the selling area, a stock product stored in the back room.

The information processing system 1200 includes a camera 1201, an information processing apparatus 1203, and a conveyance robot 1204. The camera 1201 moves in the store to capture a store shelf 1221 of a selling area 1220. Then, an image of the store shelf 1221 captured by the camera 1201 is sent to the information processing apparatus 1203. Note that the camera 1201 can move in the store by a rail 1211 installed on the ceiling of the store. Although an example in which there is provided one camera 1201 will be explained, a plurality of cameras 1201 may be provided. Furthermore, an example in which the camera 1201 moves in the horizontal direction (X and Y directions) will be described. However, the camera 1201 may be movable in the vertical direction (Z direction).

The information processing apparatus 1203 detects stockout of a product based on the image of the store shelf 1221 sent from the camera 1201. Then, the conveyance robot 1204 in a back room 1230 is notified of information concerning a detected stockout product 1223. Note that the notification destination of the information concerning the stockout product 1223 is not limited to the conveyance robot 1204, and a clerk 1232 in the back room 1230 may be notified of the information by displaying the information on a display 1233 installed in the back room 1230. Note that the display 1233 may be provided in the conveyance robot 1204.

Furthermore, the information processing apparatus 1203 controls image capturing by the camera 1201 and movement of the camera 1201. Note that if the camera 1201 is, for example, an autonomous control camera, control by the information processing apparatus 1203 is unnecessary.

Then, after the conveyance robot 1204 is notified of the information concerning the stockout product 1223, it extracts the same product as the stockout product 1223 from a store shelf 1231, places the product on the conveyance robot 1204, and conveys the product to the selling area 1220 (into the store). Note that if the clerk 1232 in the back room 1230 is notified of the information concerning the stockout product 1223, he/she may extract the same product as the stockout product 1223 from the store shelf 1231, and places the product on the conveyance robot 1204.

The conveyance robot 1204 automatically travels to a destination in the selling area 1220 to convey the stockout product 1223 to the shelf. A clerk 1222 in the selling area 1220 displays the conveyed stockout product 1223 on the store shelf 1221. Note that, for example, a product supply arm may be provided in the conveyance robot 1204, and the conveyance robot 1204 may supply the stockout product 1223 onto the store shelf 1221 automatically.

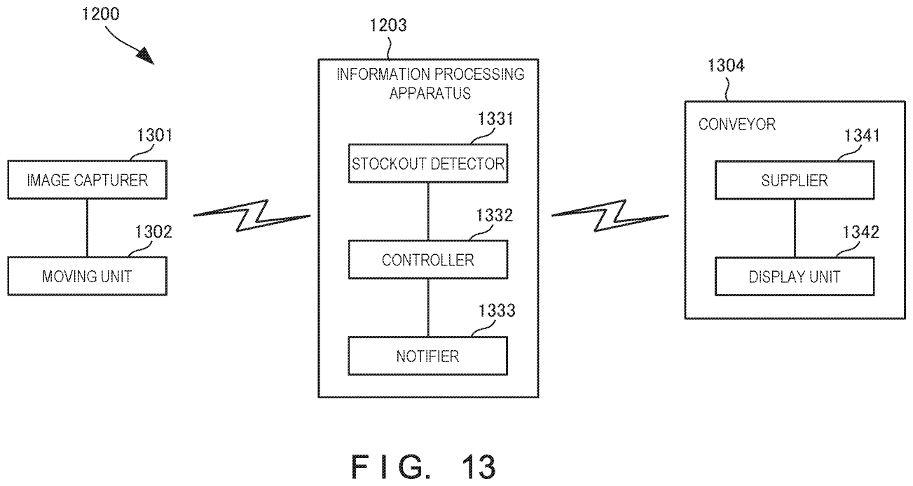

FIG. 13 is a block diagram showing the arrangement of the information processing system 1200 according to this example embodiment. The information processing system 1200 includes an image capturer 1301, a moving unit 1302, the information processing apparatus 1203, and a conveyor 1304.

The image capturer 1301 is, for example, the camera 1201 or the like, and moves in the store to capture the store shelf 1221. The image capturer 1301 transmits a captured image of the store shelf 1221 to the information processing apparatus 1203. Note that the image captured by the image capturer 1301 is a still image but may be a moving image.

The moving unit 1302 includes, for example, the rail 1211. The moving unit 1302 further includes, for example, an attachment such as a pulley. The image capturer 1301 is attached to the rail 1211 via the attachment, and can move in the store.

The information processing apparatus 1203 includes a stockout detector 1331, a controller 1332, and a notifier 1333. The stockout detector 1331 detects a stockout product based on the image of the store shelf 1221 received from the image capturer 1301.

The controller 1332 controls image capturing by the image capturer 1301 and movement of the image capturer 1301 by the moving unit 1302 at a predetermined timing.

The notifier 1333 notifies the conveyor 1304 of the information concerning the stockout product 1223 detected by the stockout detector 1331, for example, a product name, the model of the product, a photo of the product, and a location where the product is stored.

The conveyor 1304 is a mobile robot that conveys the stockout product 1223, and is, for example, the conveyance robot 1204. The conveyor 1304 includes a supplier 1341 and a display unit 1342. The supplier 1341 supplies the stockout product 1223 placed on the conveyor 1304 to display it on the store shelf 1221. The supplier 1341 is, for example, an arm that grips the stockout product 1223 placed on the conveyor 1304 and moves it from the conveyor 1304 to the store shelf 1221. Alternatively, the supplier 1341 may be a plate member that places the stockout product 1223 on a plate and supplies the stockout product 1223 to slide into the store shelf 1221. The supplier 1341 is not limited to them, and any component that can supply the stockout product 1223 to the store shelf 1221 may be adopted.

The display unit 1342 displays the information concerning the stockout product 1223 notified from the notifier 1333 of the information processing apparatus 1203. The display unit 1342 is, for example, a monitor or a display. Note that a sound or light may be generated while displaying the information concerning the stockout product 1223 on the display unit 1342. This can notify the clerk 1232 that the detection of the stockout product 1223 is made.

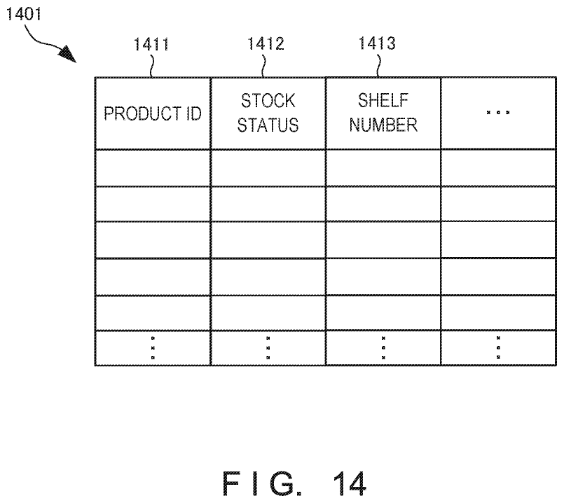

FIG. 14 is a table showing an example of a product table 1401 provided in the information processing apparatus 1203 included in the information processing system according to this example embodiment. The product table 1401 stores a stock status 1412 and a shelf number 1413 in association with a product ID (IDentifier) 1411. The product ID 1411 is an identifier for identifying a product. The stock status 1412 indicates whether there is stock of a product. The shelf number 1413 indicates a location on the store shelf 1221 in the selling area 1220, where a product is displayed, and a location on the store shelf 1231 in the back room 1230, where a product is stored. For example, the information processing apparatus 1203 replenishes the stockout product 1223 with reference to the product table 1401.

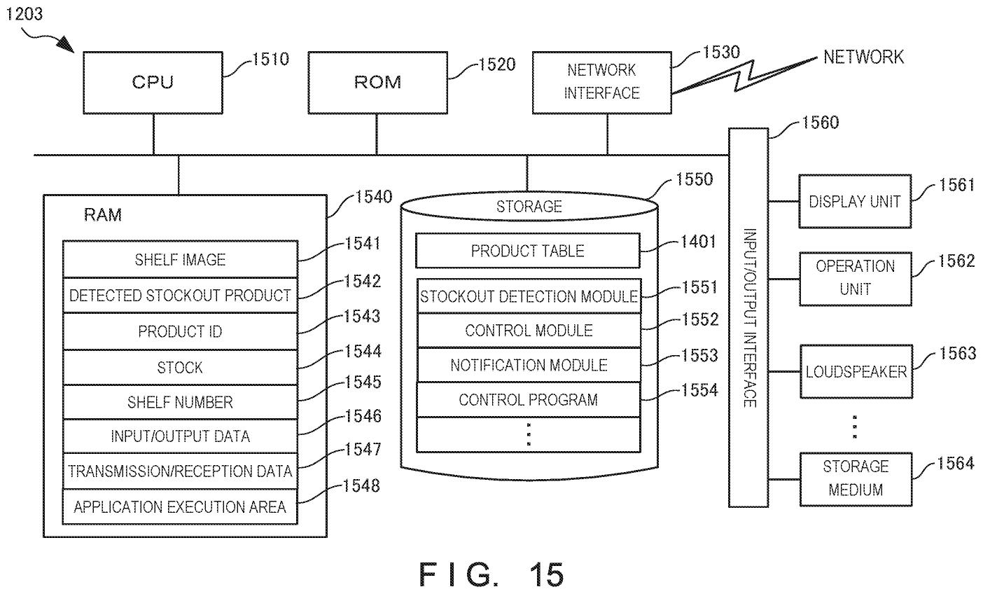

FIG. 15 is a block diagram for explaining the hardware arrangement of the information processing apparatus 1203 included in the information processing system according to this example embodiment. A CPU (Central Processing Unit) 1510 is an arithmetic control processor, and implements the functional components of the information processing apparatus 1203 shown in FIG. 13 by executing a program. The CPU 1510 may include a plurality of processors and execute different programs, modules, tasks, or threads in parallel. A ROM (Read Only Memory) 1520 stores permanent data such as initial data and a program, and other programs. A network interface 1530 communicates with another apparatus or the like via a network. Note that the number of CPUs 1510 is not limited to one, and a plurality of CPUs or a GPU (Graphics Processing Unit) for image processing may be included. The network interface 1530 desirably includes a CPU independent of the CPU 1510, and writes or reads transmission/reception data in or from the area of a RAM (Random Access Memory) 1540. It is desirable to provide a DMAC (Direct Memory Access Controller) (not shown) for transferring data between the RAM 1540 and a storage 1550. An input/output interface 1560 desirably includes a CPU independent of the CPU 1510, and writes or reads input/output data in or from the area of the RAM 1540. Therefore, the CPU 1510 recognizes that data has been received by the RAM 1540 or transferred to the RAM 1540, and processes the data. The CPU 1510 prepares a processing result in the RAM 1540, and delegates succeeding transmission or transfer to the network interface 1530, the DMAC, or the input/output interface 1560.

The RAM 1540 is a random access memory used as a temporary storage work area by the CPU 1510. An area to store data necessary for implementation of the example embodiment is allocated to the RAM 1540. A shelf image 1541 is an image obtained by capturing, by the camera 1201, the store shelf 1221 in the selling area 1220 in the store. A detected stockout product 1542 is the stockout product 1223 detected based on the image of the store shelf 1221 captured by the camera 1201. A product ID 1543 is data for identifying a product sold in the selling area 1220 in the store or a product stored in the back room 1230. A shelf number 1545 is data indicating a position on the store shelf 1221 in the selling area 1220, at which a product is displayed, or a position on the store shelf 1231 in the back room 1230, at which a product is stored. These data are loaded from, for example, the product table 1401.

Input/output data 1546 is data input/output via the input/output interface 1560. Transmission/reception data 1547 is data transmitted/received via the network interface 1530. The RAM 1540 includes an application execution area 1548 used to execute various application modules.

The storage 1550 stores a database, various parameters, or the following data or programs necessary for implementation of this example embodiment. The storage 1550 stores the product table 1401. The product table 1401 is the table, shown in FIG. 14, for managing the relationship among the product ID 1411, the stock status 1412, the shelf number 1413, and the like.

The storage 1550 further stores a stockout detection module 1551, a control module 1552, and a notification module 1553.

The stockout detection module 1551 is a module that detects stockout of a product based on the image of the store shelf 1221 captured by the camera 1201. The control module 1552 is a module that controls image capturing by the camera 1201 and movement of the camera 1201. The notification module 1553 is a module that notifies the conveyor 1304 and the like of the information concerning the stockout product 1223. These modules 1551 to 1553 are loaded to the application execution area 1548 of the RAM 1540 and executed by the CPU 1510. A control program 1554 is a program for controlling the overall information processing apparatus 1203.

The input/output interface 1560 interfaces input/output data with an input/output device. The input/output interface 1560 is connected to a display unit 1561 and an operation unit 1562. The input/output interface 1560 may also be connected to a storage medium 1564. Furthermore, a loudspeaker 1563 serving as a voice output unit, a microphone (not shown) serving as a voice input unit, or a GPS position determiner may be connected. Note that programs and data that are associated with the general-purpose functions of the information processing apparatus 1203 and other feasible functions are not shown in the RAM 1540 or the storage 1550 of FIG. 15.

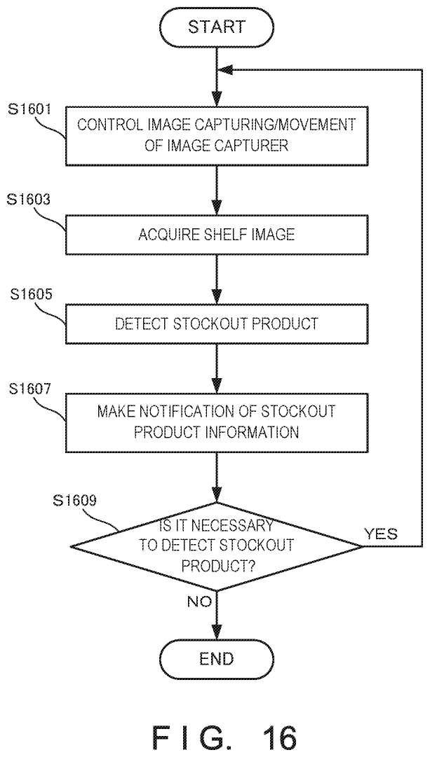

FIG. 16 is a flowchart for explaining the processing procedure of the information processing apparatus 1203 of the information processing system 1200 according to this example embodiment. This flowchart is executed by the CPU 1510 of FIG. 15 using the RAM 1540, thereby implementing the functional components of the information processing apparatus 1203 shown in FIG. 13.

In step S1601, the information processing apparatus 1203 controls movement and image capturing of the image capturer 1301 to capture an image of the store shelf 1221 in the selling area 1220. In step S1603, the information processing apparatus 1203 acquires the image of the store shelf 1221 from the image capturer 1301. In step S1605, the information processing apparatus 1203 detects stockout of a product based on the acquired image of the store shelf 1221. In step S1607, for example, the information processing apparatus 1203 notifies the conveyor 1304 of the information concerning the stockout product 1223. In step S1609, the information processing apparatus 1203 determines whether it is necessary to further detect the stockout product 1223. If it is necessary to detect the stockout product 1223 (YES in step S1609), the information processing apparatus 1203 returns to step S1601; otherwise (NO in step S1609), the information processing apparatus 1203 ends the processing.

According to this example embodiment, it is possible to convey a stockout product into the store more efficiently. Furthermore, since the stockout product is conveyed to the selling area by the conveyance robot, it is possible to largely reduce the clerk's labor. In addition, a procedure from detection of a stockout product to display of the product can be automated by making the conveyance robot display the stockout product, thereby more largely reducing the clerk's labor. Since detection of a stockout product can be automated, it is possible to prevent the loss of a sales opportunity to store visitors.

### Sixth Example Embodiment

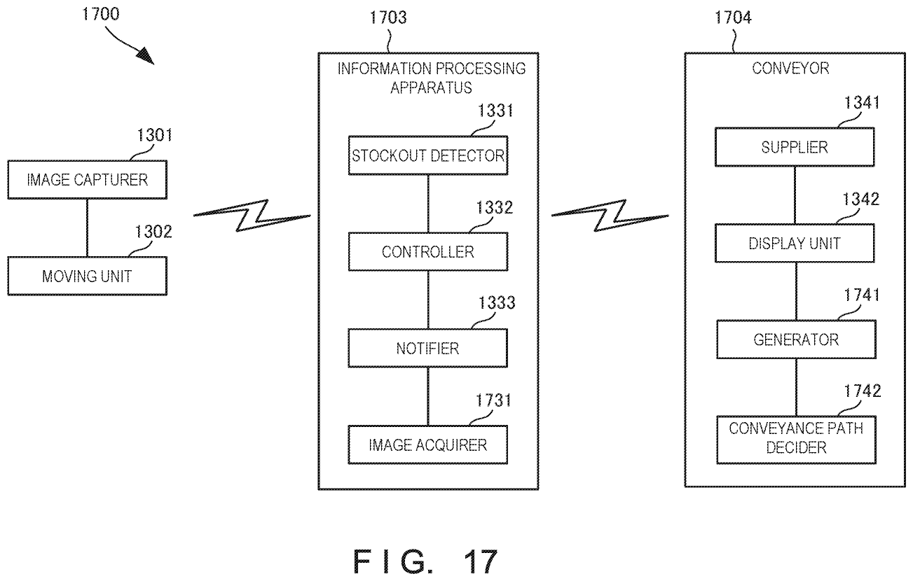

An information processing system 1700 according to the sixth example embodiment of the present invention will be described next with reference to FIGS. 17 to 20. FIG. 17 is a block diagram for explaining the arrangement of an information processing system 1700 according to this example embodiment. The information processing system 1700 according to this example embodiment is different from that in the fifth example embodiment in that an information processing apparatus includes an image acquirer and a conveyor includes a generator and a conveyance path decider. The remaining components and operations are the same as those in the fifth example embodiment. Hence, the same reference numerals denote the same components and operations, and a detailed description thereof will be omitted.

An information processing apparatus 1703 includes an image acquirer 1731. The image acquirer 1731 acquires an image captured by an image capturer 1301. Then, a stockout detector 1331 detects stockout of a product based on the image acquired by the image acquirer 1731.

A conveyor 1704 includes a generator 1741 and a conveyance path decider 1742. If, for example, the conveyor 1704 that can self-travel in a store conveys a stockout product 1223 to a selling area 1220 in the store, the generator 1741 generates a moving history in the store from traveling data obtained when traveling in the store, and generates a floor map (selling area map) based on the generated moving history.

A floor map is generated by, for example, grasping the current position of the conveyor 1704 using a GPS (Global Positioning System), and deriving a moving history from traveling data obtained when the conveyor 1704 travels in the store including the selling area 1220 and a back room 1230. Alternatively, a floor map may be generated by grasping the current position of the conveyor 1704 using a beacon or radio waves of short distance wireless communication such as Wi-Fi, instead of the GPS, and deriving a moving history from traveling data obtained when the conveyor 1704 travels in the store.

Furthermore, an obstacle detection sensor may be provided in the conveyor 1704. A floor map may be generated based on the arrangement status of an obstacle detected by the obstacle detection sensor provided in the conveyor 1704. Alternatively, a floor map may be generated by combining data of the GPS, the beacon, or the like with data acquired by the obstacle detection sensor. The design drawing data of the store, in-store layout data, or the like may be input to the generator 1741, and then a floor map may be generated from the input data.

Based on the generated floor map, the conveyance path decider 1742 decides a conveyance path from the back room 1230 to the selling area 1220 or a return path from the selling area 1220 to the back room 1230. For example, the conveyance path decider 1742 extracts, from information concerning the stockout product 1223 notified from a notifier 1333 of an information processing apparatus 1203, the position of a store shelf 1221 in the selling area 1220 to which the stockout product 1223 is to be conveyed, and decides a round path when conveying the stockout product 1223 to the store shelf 1221. Note that the arrangement in which the conveyor 1704 includes the conveyance path decider 1742 has been explained. However, for example, the information processing apparatus 1203 may include the conveyance path decider 1742. If the information processing apparatus 1203 includes the conveyance path decider 1742, the notifier 1333 of the information processing apparatus 1203 notifies the conveyor 1704 of the stockout product 1223 and also the conveyance path.

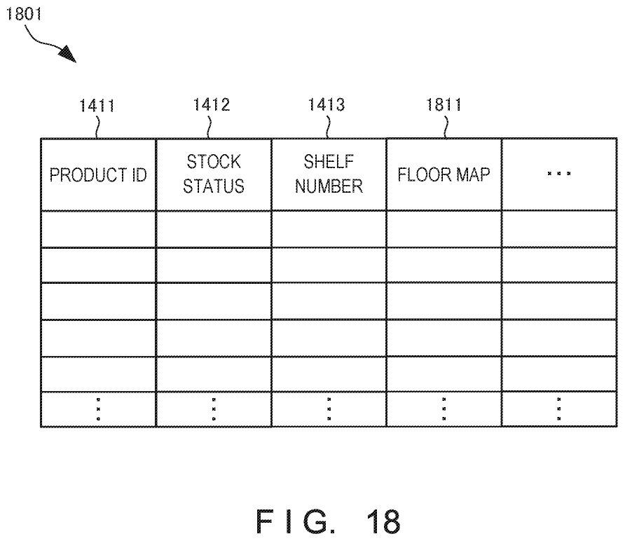

FIG. 18 is a table showing an example of a product table 1801 provided in the conveyor 1704 included in the information processing system 1700 according to this example embodiment. The product table 1801 stores a floor map 1811 in association with a product ID 1411. The floor map 1811 indicates a position on the floor map 1811, to which a product corresponding to the product ID 1411 is to be conveyed.

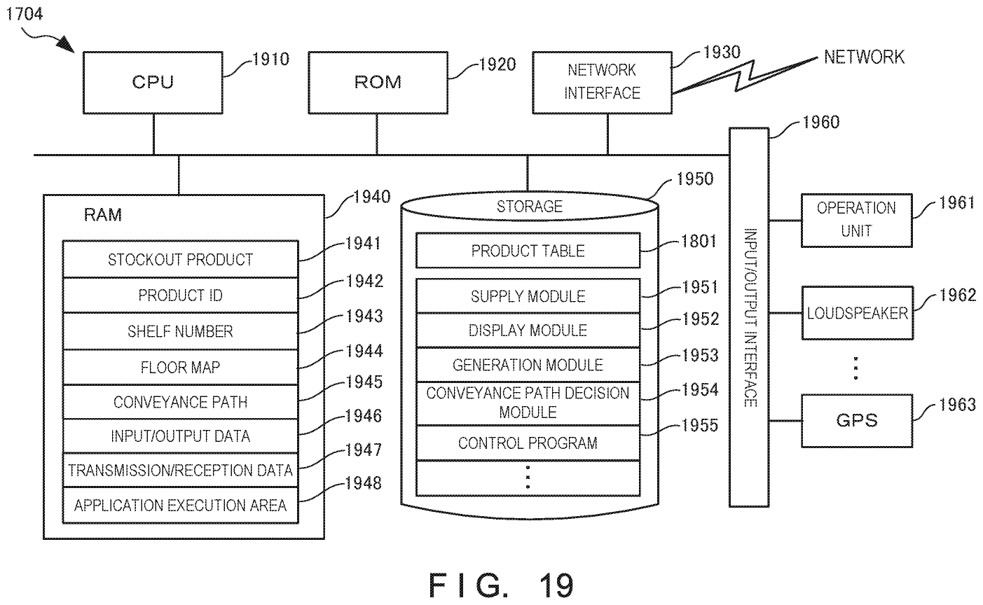

FIG. 19 is a block diagram for explaining the hardware arrangement of the conveyor 1704 included in the information processing system 1700 according to this example embodiment. A CPU (Central Processing Unit) 1910 is an arithmetic control processor, and implements the functional components of the conveyor 1704 shown in FIG. 17 by executing a program. The CPU 1910 may include a plurality of processors and execute different programs, modules, tasks, or threads in parallel. A ROM (Read Only Memory) 1920 stores permanent data such as initial data and a program, and other programs. A network interface 1930 communicates with another apparatus or the like via a network. Note that the number of CPUs 1910 is not limited to one, and a plurality of CPUs or a GPU (Graphics Processing Unit) for image processing may be included. The network interface 1930 desirably includes a CPU independent of the CPU 1910, and writes or reads transmission/reception data in or from the area of a RAM (Random Access Memory) 1940. It is desirable to provide a DMAC (Direct Memory Access Controller) (not shown) for transferring data between the RAM 1940 and a storage 1950. An input/output interface 1960 desirably includes a CPU independent of the CPU 1910, and writes or reads input/output data in or from the area of the RAM 1940. Therefore, the CPU 1910 recognizes that data has been received by the RAM 1940 or transferred to the RAM 1940, and processes the data. The CPU 1910 prepares a processing result in the RAM 1940, and delegates succeeding transmission or transfer to the network interface 1930, the DMAC, or the input/output interface 1960.

The RAM 1940 is a random access memory used as a temporary storage work area by the CPU 1910. An area to store data necessary for implementation of the example embodiment is allocated to the RAM 1940. A stockout product 1941 is information concerning a stockout product detected by the stockout detector 1331 of the information processing apparatus 1203 and notified from the notifier 1333. A product ID 1942 is data for identifying a product or the like stored in the back room 1230. A shelf number 1943 is data indicating a position on the store shelf 1221 in the selling area 1220, at which a product is displayed, or a position on the store shelf 1231 in the back room 1230, at which a product is stored. A floor map 1944 is an in-store map including the selling area 1220 and the back room 1230. A conveyance path 1945 is a route along which the conveyor 1704 travels when conveying a product to the selling area 1220. These data are data loaded from, for example, the product table 1801.

Input/output data 1946 is data input/output via the input/output interface 1960. Transmission/reception data 1947 is data transmitted/received via the network interface 1930. The RAM 1940 includes an application execution area 1948 used to execute various application modules.

The storage 1950 stores a database, various parameters, or the following data or programs necessary for implementation of this example embodiment. The storage 1950 stores the product table 1801. The product table 1801 is the table, shown in FIG. 18, for managing the relationship among the product ID 1411, the floor map 1811, and the like.

The storage 1950 further stores a supply module 1951, a display module 1952, a generation module 1953, and a conveyance path decision module 1954. The supply module 1951 is a module that supplies the stockout product 1223 to display, at a predetermined position on the store shelf 1221, the stockout product 1223 conveyed to the selling area 1220. The display module 1952 is a module that displays the information concerning the stockout product 1223 notified from the information processing apparatus 1203. The generation module 1953 is a module that generates a floor map as an in-store map based on a moving history (traveling history) obtained when the conveyor 1704 moves in the store. The conveyance path decision module 1954 is a module that decides a conveyance path (traveling path) when the conveyor 1704 conveys the stockout product 1223 from the back room 1230 to the store shelf 1221 in the selling area 1220. These modules 1951 to 1954 are loaded to the application execution area 1948 of the RAM 1940 and executed by the CPU 1910. A control program 1955 is a program for controlling the overall conveyor 1704.

The input/output interface 1960 interfaces input/output data with an input/output device. The input/output interface 1960 is connected to an operation unit 1961. The input/output interface 1960 may also be connected to a GPS 1963. Furthermore, a loudspeaker 1962 serving as a voice output unit and a microphone (not shown) serving as a voice input unit may be connected. Note that programs and data that are associated with the general-purpose functions of the conveyor 1704 and other feasible functions are not shown in the RAM 1940 or the storage 1950 of FIG. 19.

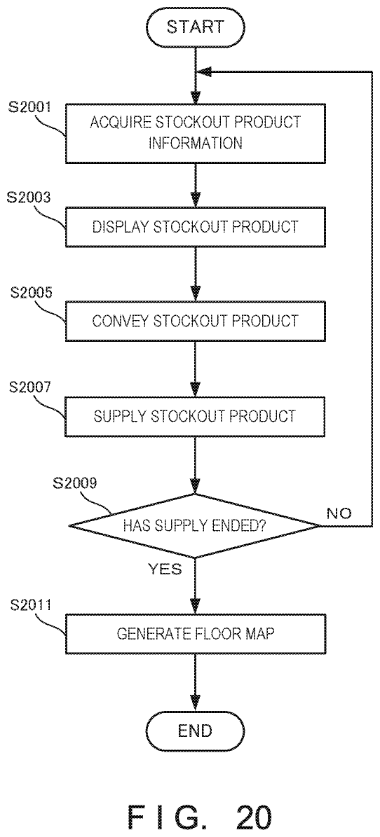

FIG. 20 is a flowchart for explaining the processing procedure of the conveyor 1704 of the information processing system 1700 according to this example embodiment. This flowchart is executed by the CPU 1910 of FIG. 19 using the RAM 1940, thereby implementing the functional components of the conveyor 1704 shown in FIG. 17.

In step S2001, the conveyor 1704 acquires information concerning a stockout product. In step S2003, the conveyor 1704 displays the information concerning the stockout product 1223 on a display unit 1342. Then, a clerk 1232 in the back room 1230 places, on the conveyor 1704, the stockout product 1223 displayed on the display unit 1342. Note that if the conveyor 1704 goes to get the stockout product 1223, step S2003 may be omitted.

In step S2005, the conveyor 1704 conveys the stockout product 1223 to the store shelf 1221 in the selling area 1220. In step S2007, the conveyor 1704 supplies and displays the stockout product 1223 to the predetermined position on the store shelf 1221 using the arm or the like. Note that when a clerk 1222 displays the stockout product 1223 on the store shelf 1221, step S2007 may be omitted. In step S2009, the conveyor 1704 determines whether supply of the stockout product 1223 to the store shelf 1221 has ended. If it is determined that supply has not ended (NO in step S2009), the conveyor 1704 returns to step S2001; otherwise (YES in step S2009), the conveyor 1704 advances to step S2011.

In step S2011, the conveyor 1704 generates a floor map based on the moving history in the store. Note that the timing of generating a floor map is not limited to the timing at which supply of the stockout product 1223 ends. For example, a floor map may be generated while the conveyor 1704 travels (moves) in the store.

According to this example embodiment, since the conveyor generates a floor map, it is possible to convey a stockout product to a store shelf more efficiently and accurately.

### Seventh Example Embodiment

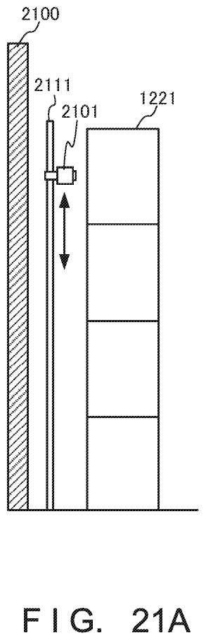

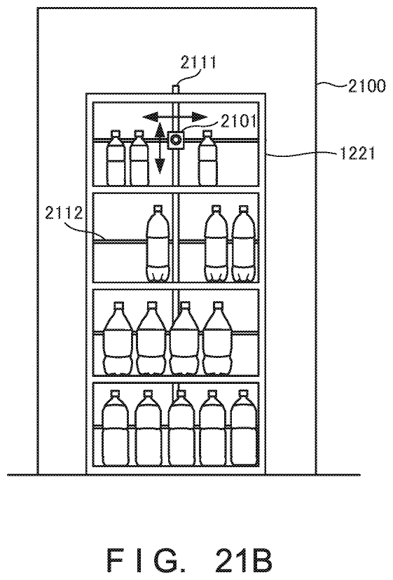

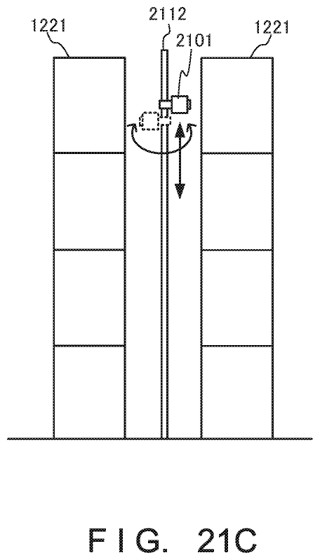

An information processing system according to the fourth example embodiment of the present invention will be described next with reference to FIGS. 21A to 21C. FIG. 21A is a side view for explaining examples of an image capturer and a moving unit in an information processing system according to this example embodiment. FIG. 21B is a front view for explaining other examples of the image capturer and the moving unit in the information processing system according to this example embodiment. FIG. 21C is a side view for explaining still other examples of the image capturer and the moving unit in the information processing system according to this example embodiment.

The information processing system according to this example embodiment is different from those in the second and third example embodiments in that the image capturer and the moving unit are provided behind a store shelf. The remaining components and operations are the same as those in the second and third example embodiments. Hence, the same reference numerals denote the same components and operations, and a detailed description thereof will be omitted.

As shown in FIG. 21A, if a store shelf 1221 is installed against a wall 2100, a rail 2111 may be provided between the wall 2100 and the store shelf 1221, and a camera 2101 may be attached to the rail 2111. Furthermore, as shown in FIG. 21B, rails 2112 that can move the camera 2101 in the lateral direction (horizontal direction) may be provided. With this arrangement of the rails 2111 and 2112, it is possible to move the camera 2101 in the longitudinal direction (vertical direction) and the lateral direction (horizontal direction). Note that if no lateral rail 2111 is provided as a rail that moves the camera 2101, a pan function and a tilt function may be provided in the camera 2101.

As shown in FIG. 21C, if the store shelves 1221 are installed back to back, the rail 2112 may be provided between the store shelves 1221, and the camera 2101 may be attached to the rail 2112. In this case, the rail 2112 that can move the camera 2101 in the lateral direction may be provided. If no rail 2112 is provided, a pan function and a tilt function may be provided in the camera 2101 to make it possible to capture the store shelf 1221 in front of the camera 2101 and the store shelf 1221 behind the camera 2101.

Alternatively, a rope may be drawn on the ceiling of the store, instead of the rail 2112 or the like, and the camera 2101 may be hung down from the rope to be moved. The camera 2101 may be provided in an unmanned aircraft such as a drone to be moved in the store.

According to this example embodiment, since the image capturer and the moving unit are provided behind the store shelf, it is possible to detect stockout of a product without obstructing a store visitor seeing a product. In addition, it is possible to readily move the image capturer in the vertical direction.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described example embodiments can also be described as in the following supplementary notes but are not limited to the followings.

(Supplementary Note 1)

There is provided an information processing system comprising:

at least one image capturer that captures a store shelf;

a moving unit that moves the image capturer; and

a controller that controls image capturing by the image capturer and movement of the image capturer by the moving unit at a predetermined timing.

(Supplementary Note 2)

There is provided the information processing system according to supplementary note 1, wherein the predetermined timing is a timing after detecting a change in state of the store shelf.

(Supplementary Note 3)

There is provided the information processing system according to supplementary note 1 or 2, wherein the predetermined timing is a timing at which a product arrives at a store.

(Supplementary Note 4)

There is provided the information processing system according to any one of supplementary notes 1 to 3, wherein the predetermined timing is a timing a predetermined time before a sales deadline of a product displayed in the store.

(Supplementary Note 5)

There is provided the information processing system according to any one of supplementary notes 1 to 4, wherein the predetermined timing is a timing after a product is sold.

(Supplementary Note 6)

There is provided the information processing system according to any one of supplementary notes 1 to 5, wherein the predetermined timing is a timing after detecting customers concentrating around a predetermined store shelf.

(Supplementary Note 7)

There is provided the information processing system according to any one of supplementary notes 1 to 6, wherein the controller shortens an interval of image capturing by the image capturer and movement by the moving unit in a predetermined time period before a start of an event around the store.

(Supplementary Note 8)

There is provided the information processing system according to any one of supplementary notes 1 to 7, further comprising a stock determiner that determines whether there is stock of a product in a back room, wherein the controller controls image capturing and movement of the image capturer based on a determination result by the stock determiner.

(Supplementary Note 9)

There is provided the information processing system according to supplementary note 8, wherein if the stock determiner determines that there is no stock, the controller suppresses control of image capturing and movement of the image capturer.

(Supplementary Note 10)

There is provided the information processing system according to any one of supplementary notes 1 to 9, wherein the moving unit includes a rail installed in the store.

(Supplementary Note 11)

There is provided the information processing system according to supplementary note 10, wherein the rail is installed on a ceiling of the store.

(Supplementary Note 12)

There is provided the information processing system according to supplementary note 1, further comprising:

a stockout detector that detects stockout of a product based on an image of the store shelf captured by the image capturer; and

a conveyor that conveys a stockout product detected by the stockout detector from a back room into a store.

(Supplementary Note 13)

There is provided the information processing system according to supplementary note 12, further comprising a notifier that makes a notification of information of the stockout product.

(Supplementary Note 14)

There is provided the information processing system according to supplementary note 13, further comprising a display unit that displays the information of the stockout product notified from the notifier.

(Supplementary Note 15)

There is provided the information processing system according to supplementary note 14, wherein the display unit is installed in the conveyor.

(Supplementary Note 16)

There is provided the information processing system according to any one of supplementary notes 12 to 15, wherein the conveyor further includes a supplier that supplies the stockout product to a predetermined position on the store shelf.

(Supplementary Note 17)

There is provided the information processing system according to any one of supplementary notes 12 to 16, wherein the moving unit includes a rail installed in the store.

(Supplementary Note 18)

There is provided the information processing system according to any one of supplementary notes 12 to 17, wherein the rail is installed on a ceiling of the store.

(Supplementary Note 19)

There is provided the information processing system according to any one of supplementary notes 12 to 18, wherein the conveyor further includes a generator that can self-travel in the store, and generates a floor map based on a moving history in the store, and a conveyance path decider that decides, based on the generated floor map, a conveyance path along which the stockout product is conveyed into the store.

(Supplementary Note 20)

There is provided an information processing apparatus comprising:

a timing generator that generates, based on taking-in/out of a product in a store, a timing of image capturing of at least one image capturer that captures a store shelf and movement of the image capturer by a moving unit; and

a controller that controls image capturing by the image capturer and movement of the image capturer by the moving unit at the timing.

(Supplementary Note 21)

There is provided the information processing apparatus according to supplementary note 20, further comprising:

an image acquirer that acquires an image captured by the image capturer;

a stockout detector that detects stockout of a product based on the acquired image; and

a notifier that makes a notification of information concerning a stockout product detected by the stockout detector.

(Supplementary Note 22)

There is provided an information processing method comprising:

generating, based on taking-in/out of a product in a store, a timing of image capturing of at least one image capturer that captures a store shelf and movement of the image capturer by a moving unit; and controlling image capturing by the image capturer and movement of the image capturer by the moving unit at the timing.

(Supplementary Note 23)

There is provided the information processing method according to supplementary note 22, further comprising:

acquiring an image captured by the image capturer;

detecting stockout of a product based on the acquired image; and

making a notification of information concerning a stockout product detected in the detecting.

(Supplementary Note 24)

There is provided an information processing program for causing a computer to execute a method, comprising:

generating, based on taking-in/out of a product in a store, a timing of image capturing of at least one image capturer that captures a store shelf and movement of the image capturer by a moving unit; and

controlling image capturing by the image capturer and movement of the image capturer by the moving unit at the timing.

(Supplementary Note 25)

There is provided the information processing program according to supplementary note 24, wherein the information processing program causes the computer to further execute

acquiring an image captured by the image capturer;

detecting stockout of a product based on the acquired image; and

making a notification of information concerning a stockout product detected in the detecting.

1-25. (canceled)

26. An information processing apparatus comprising:
a timing generator that generates, based on taking-in/out of a product in a store, a timing of image capturing of at least one image capturer that captures a store shelf and movement of the image capturer by a moving unit; and
a controller that controls image capturing by the image capturer and movement of the image capturer by the moving unit at the timing.

27. The information processing apparatus according to claim 26, further comprising a stock determiner that determines whether there is stock of a product in a back room,
wherein said controller controls image capturing and movement of said image capturer based on a determination result by said stock determiner.

28. The information processing apparatus according to claim 27, wherein if said stock determiner determines that there is no stock, said controller suppresses control of image capturing of said image capturer.

29. The information processing apparatus according to claim 27, wherein if said stock determiner determines that there is no stock, said controller suppresses control of movement of said image capturer.

30. The information processing apparatus according to claim 27, wherein said controller shortens an interval of image capturing by said image capturer in a predetermined time period before a start of an event around the store.

31. The information processing apparatus according to claim 27, wherein said controller shortens an interval of image movement by said moving unit in a predetermined time period before a start of an event around the store.

32. The information processing apparatus according to claim 27, further comprising:
a stockout detector that detects stockout of a product based on an image of the store shelf captured by said image capturer;
wherein said controller instructs a conveyor, that conveys a stockout product detected by said stockout detector from a back room into a store, to supply the stockout product to a predetermined position on the store shelf.

33. The information processing apparatus according to claim 32, further comprising a notifier that makes a notification of information of the stockout product.

34. The information processing apparatus according to claim 33, further comprising a display unit that displays the information of the stockout product notified from said notifier.

35. An information processing method comprising:
generating, based on taking-in/out of a product in a store, a timing of image capturing of at least one image capturer that captures a store shelf and movement of the image capturer by a moving unit; and
controlling image capturing by the image capturer and movement of the image capturer by the moving unit at the timing.

36. The information processing method according to claim 35, further comprising determining whether there is stock of a product in a back room,
wherein in the controlling, image capturing and movement of said image capturer are controlled based on a determination result by said stock determiner.

37. An information processing system comprising:
at least one image capturer that captures a store shelf;
a moving unit that moves said image capturer; and
a controller that controls image capturing by said image capturer and movement of said image capturer by said moving unit at a predetermined timing.

38. The information processing system according to claim 37, further comprising a stock determiner that determines whether there is stock of a product in a back room,
wherein said controller controls image capturing and movement of said image capturer based on a determination result by said stock determiner.

39. The information processing system according to claim 38, further comprising:
a stockout detector that detects stockout of a product based on an image of the store shelf captured by said image capturer; and
a conveyor that conveys a stockout product detected by said stockout detector from a back room into a store.

40. The information processing system according to claim 39, further comprising a display unit that displays the information of the stockout product, wherein said display unit is installed in said conveyor.

41. The information processing system according to claim 37, wherein said conveyor further includes a supplier that supplies the stockout product to a predetermined position on the store shelf.

42. The information processing system according to claim 37, wherein said conveyor further includes
a generator that generates a floor map based on a moving history in the store, and
a conveyance path decider that decides, based on the generated floor map, a conveyance path along which the stockout product is conveyed into the store.

43. The information processing apparatus according to claim 37, wherein said conveyor can self-travel in the store.
